(19) United States
(12) Patent Application Publication
(10) Pub. No.: US 2008/0172232 A1
(43) Pub. Date: Jul. 17, 2008

(54) VOICE TRIGGERED EMERGENCY ALERT

(76) Inventor: Scott A. Gurley, Austin, TX (US)

Correspondence Address: Rory D. Rankin;Meyertons, Hood, Kivlin, Kowert & Goetzel, P.C., P.O. Box 398, Austin, TX, 78767-0398, US

(21) Appl. No.: 12/013,993

(22) Filed: Jan. 14, 2008

Related U.S. Application Data
(60) Provisional application No. 60/884,833, filed on Jan. 12, 2007.

(51) Int. Cl. G10L 15/02

(52) U.S. Cl. 704/251; 704/E15.007

(57) ABSTRACT

A voice recognition emergency system and method. The system includes a microphone, a speaker, and a voice recognition emergency device. The device includes a processor and a transmitter. The processor analyzes sound received from the microphone, detects when an emergency phrase has been spoken, and conveys an alert condition to a gateway via the transmitter in response to detecting the emergency phrase has been spoken. The processor recognizes pre-defined, spoken emergency phrases and triggers an alert condition in response to detecting that one of the emergency phrases was spoken. The device continuously listens through the microphone for any one of the pre-defined phrases, in response to which an alert condition is conveyed to the gateway device. The alert condition is conveyed to the gateway device through Power Line Communications (PLC), radio communications, Wi-Fi communications, or Ethernet communications. The processor may recognize an emergency phrase spoken by a particular person.

This application claims benefit of priority of U.S. Provisional Patent Application No. 60/884,833 filed on Jan. 12, 2007, the entirety of which is incorporated herein by reference.

### BACKGROUND OF THE INVENTION

1. Field of the Invention

This invention relates to methods and systems for monitoring the condition and health of a person in a building, normally the person's residence, and more particularly, to interactive methods of summoning help.

2. Description of the Related Art

Frail, elderly people and others with chronic diseases or handicaps, especially those with mobility problems, may have difficulty in summoning help if they fall, or need help for any other reason, for example by using the telephone or a conventional emergency panic button. Conventional panic button systems involve the person wearing a device and pushing a button on the device in an emergency situation. The device then sends an alert by radio transmission to a dialler and/or broadband adapter and/or cellular device and/or pager that connects to emergency services or to a remote monitoring center, which can then take appropriate action. In many instances, elderly people in particular are unable to press the button, and may simply fall into an unconscious state or may become severely disoriented. Some devices activate a speakerphone, but again if the device is not activated, the speakerphone will not activate. Additionally the wearable devices can be awkward and so the person may not wear the device while sleeping when a majority of needs for assistance take place. In addition, conventional panic button systems have limited ability to provide detailed information to a responder about the nature of assistance needed. Accordingly, what is needed are system and methods of monitoring the condition and health of a person that are less dependent on actions that may be difficult for the person to perform and that provide some degree of interactivity between the person needing help and the responder.

### SUMMARY OF THE INVENTION

Various embodiments of a system and methods for monitoring the safety of a person in a building are disclosed. The system includes a microphone, a speaker, and a voice recognition emergency device. The voice recognition emergency device comprises a transmitter for communication with a gateway and a processor. The processor analyzes sound received from the microphone, detects when an emergency phrase has been spoken, and conveys an alert condition to the gateway via the transmitter in response to detecting the emergency phrase has been spoken.

In one embodiment, the processor recognizes any of a plurality of pre-defined, spoken emergency phrases and trigger an alert condition in response to detecting that one of the emergency phrases was spoken. In a further embodiment, the device continuously listens through the microphone for any one of the pre-defined phrases, in response to which an alert condition is conveyed to the gateway device. The alert condition is conveyed to the gateway device through Power Line Communications (PLC), radio communications, Wi-Fi communications, or Ethernet communications.

In another embodiment, the processor recognizes an emergency phrase spoken by a particular person. In another embodiment, the system further comprises a call center coupled to the gateway via a network and a caregiver coupled to the call center. In response to receiving the alert condition, the gateway conveys the alert condition to the call center and the call center responds to the alert condition. In a further embodiment, the call center responds to the alert condition by summoning help from the caregiver upon determining that the alert is not a false alarm. In an alternative embodiment, a caregiver is coupled to the gateway and the gateway responds to the alert condition by summoning help from the caregiver.

In order that the invention may be better understood, a preferred embodiment will now be described with reference to the accompanying schematic drawings, in which:

### BRIEF DESCRIPTION OF THE DRAWINGS

FIG. 1 illustrates one embodiment of a system that includes a voice recognition emergency device coupled to a microphone and a speaker.

FIG. 2 illustrates one embodiment of a network of voice recognition emergency devices that may be installed in a residence.

FIG. 3 is a block diagram of one embodiment of a voice triggered emergency alert system.

FIG. 4 illustrates one embodiment of a voice triggered emergency alert process.

FIG. 5 illustrates one embodiment of a web-based view of part of a database that may be used in a voice triggered emergency alert system.

While the invention is susceptible to various modifications and alternative forms, specific embodiments are shown by way of example in the drawings and are herein described in detail. It should be understood, however, that drawings and detailed descriptions thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

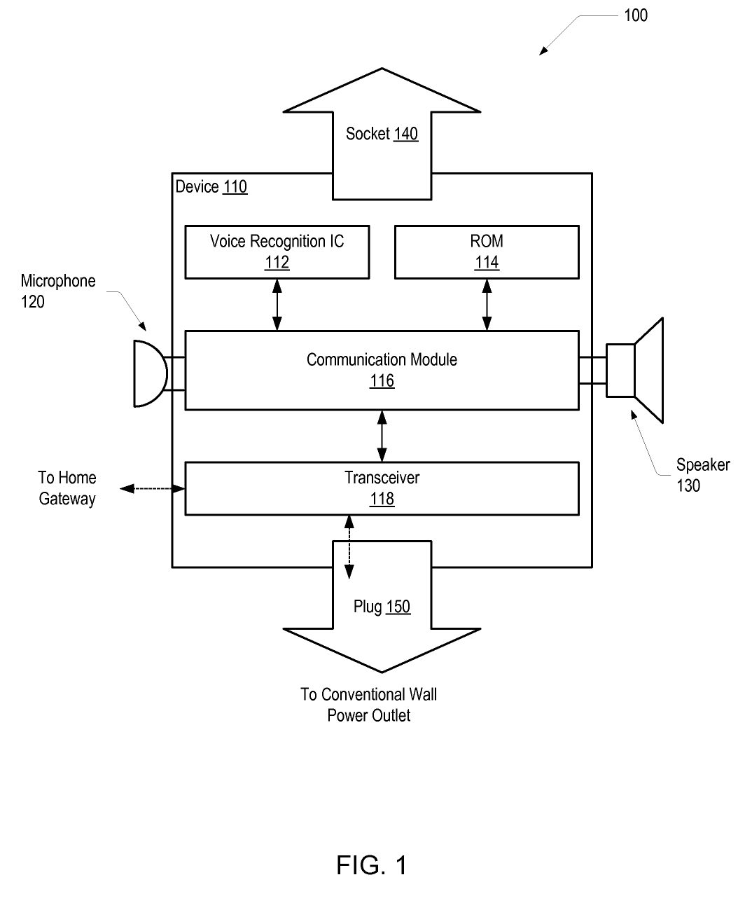

FIG. 1 illustrates one embodiment of a system 100 that includes a voice recognition emergency device 110, coupled to a microphone 120 and a speaker 130. In the illustrated embodiment, device 110 includes an integrated circuit 112 for performing voice recognition, a ROM 114 for storing rules, a two-way voice communication module 116, and a transceiver 118. Device 110 may be powered by either an internal battery (not shown), which is preferably rechargeable, or through a wall power outlet. In the illustrated embodiment, device 110 includes a plug 150 for connection to a conventional wall power outlet. The prongs of plug 150 may be located directly on the device. Device 150 is also shown to include a 3-hole socket 140 through which standard household appliances may be plugged into the device to receive power from the same wall power outlet to which plug 150 is connected.

In various embodiments, transceiver 118 may provide communication between device 110 and a home gateway using one or more of a variety of protocols such as Z-wave wireless communication, Zigbee, Power Line Communication (PLC), Wi-Fi or Ethernet. In one embodiment, using the PLC protocol, device 110 may communicate directly through plug 150, when it is connected to a conventional wall power outlet. The home gateway may be connected to a 24/7 call center through which immediate help may be summoned. In brief, a person needing help may speak any number of relevant, pre-defined key phrases or words that are recognizable to device 110 in order to cause an alert to be sent to the home gateway. For example, a trigger phrase may be “help 911”. In one embodiment, device 110 may be configured to recognize one or more key phrases or words that are determined or selected by the person needing help. Further details of the operation of a home gateway and the interactions between responders and a person needing help are presented below.

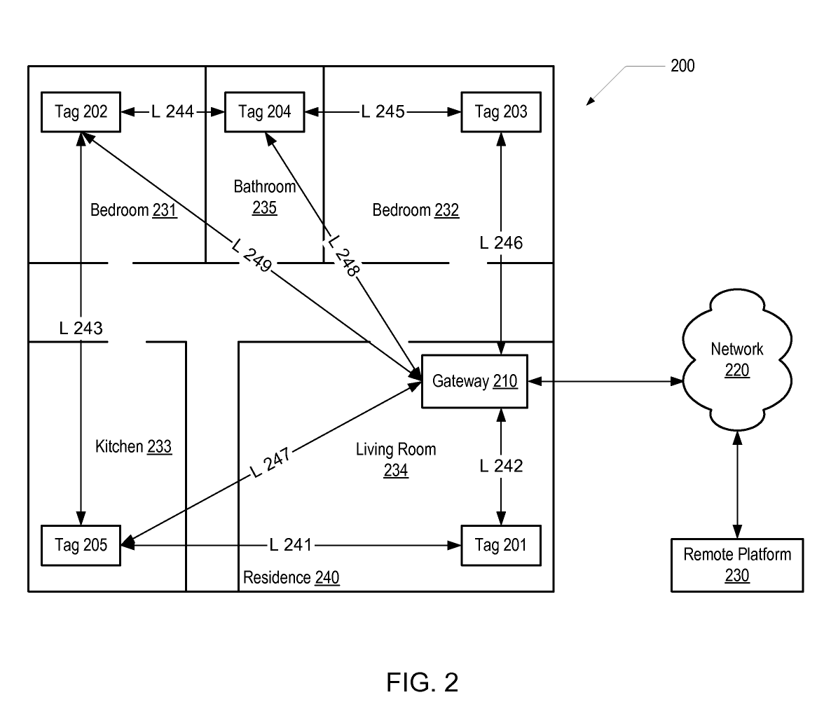

FIG. 2 illustrates one embodiment of a network 200 of voice recognition emergency devices that may be installed in a residence 240. Residence 240 includes a bedroom 231, a bedroom 232, a kitchen 233, a living room 234, and a bathroom 235. Network 200 includes tags 201-205 coupled to a gateway 210 for communication with an external emergency care provider. For example, as shown, gateway 210 may be coupled to a remote platform 230 via an external network 220. Each of tags 201-205 may be a system such as system 100 of FIG. 1, including a voice recognition emergency device such as device 110. Tags 201-205 may be installed at fixed locations distributed around the house. In alternative embodiments, the installation locations of tags 201-205 may be changed as desired. For example, tags may be plugged into any available wall power outlet and moved from outlet to outlet in a given room when furniture is moved, outlets are used for other devices, etc. In other embodiments, more than five or fewer than five tags may be included in network 200 and the number of tags within network 200 may be changed as needed.

During operation, each of tags 201-205 may continuously listen to the noise throughout its audible range using its included microphone. If a pre-defined keyword or phrase is recognized a tag may send an alert to gateway 210. Each of tags 201-205 may communicate with other tags and gateway 210 through one or more of radio communication, PLC, Wi-Fi, or Ethernet, etc. links such as links 241-249 as shown. In the illustrated embodiment, links 242, 249, 246, 248, and 247 couple tags 201, 202, 203, 204, and 205, respectively, directly to gateway 210. In addition, tag 201 may be coupled to tag 205 via link 241, tag 202 may be coupled to tag 205 via link 243, tag 202 may be coupled to tag 204 via link 244, and tag 203 may be coupled to tag 204 via link 245. Accordingly, if obstacles for the various types of transmission, such as walls and electromagnetic interference from strong emitters such as refrigerators, are present, communication between a tag and gateway 210 may be relayed through one or more other tags. For example, tag 205 may communicate with gateway 210 via either link 247 or a path including link 241, tag 201, and link 242. Data from the gateway 210 may be returned in a similar manner. Such redundant connections are well known in the art, and will not be described further in this specification. In one embodiment, each tag includes a voice recognition IC that may recognize one or more pre-defined keywords or phrases. In further embodiments, the voice recognition IC may be include hardware, software, or firmware to enable it to be trained to recognize the voice of one or more particular people speaking the pre-defined keywords or phrases. In alternative embodiments, the voice recognition functionality for a set of tags may be centrally located, such as in gateway 210 or some other central location.

It may be appreciated that in addition to system 100, a variety of different sensors could be used to help confirm a specific event: for example smoke alarms, home alarms, carbon monoxide or other sensors, in addition to the voice recognition tag device. Such events include fires and dangerous emissions, as well as falls. Data from such sensors may be sent to gateway 210 for inclusion in alert notifications.

Gateway 210 may include a transceiver for communicating with the tags, which may be via radio, Ethernet, PLC, Wi-Fi, etc. Gateway 210 may also include a data processor for storing and processing data from tags 202-205. In one embodiment, gateway 210 may be powered from a conventional wall power outlet. In order to communicate with the remote platform, the gateway 210 may be coupled via a telephone dialler, wireless modem, cable modem, or satellite modem (not shown) to network 220. Network 220 may include the Internet, a mobile network, and/or the public switched telephone network (PSTN).

In alternative embodiments, gateway 210 may be a standalone-unit or a component of a home router, media gateway, computer or other network-connected device. In one embodiment, gateway 210 may include a programmable interface. For example, gateway 210 may provide a web-based, Internet-accessible interface for configuring network 200. In a further embodiment, a user may configure one or more of tags 201-205 to operate on a schedule. For example, a user may configure network 200 to be disabled during a vacation period and to re-start at a selected time when the vacation period is expected to end. In another embodiment, a user may program the operation of tags 201-205 either individually or collectively through gateway 210. In a still further embodiment, a user may program the operation of tags 201-205, either individually or collectively, from a computer, telephone, or other suitable device that is connected to gateway 210 via network 220.

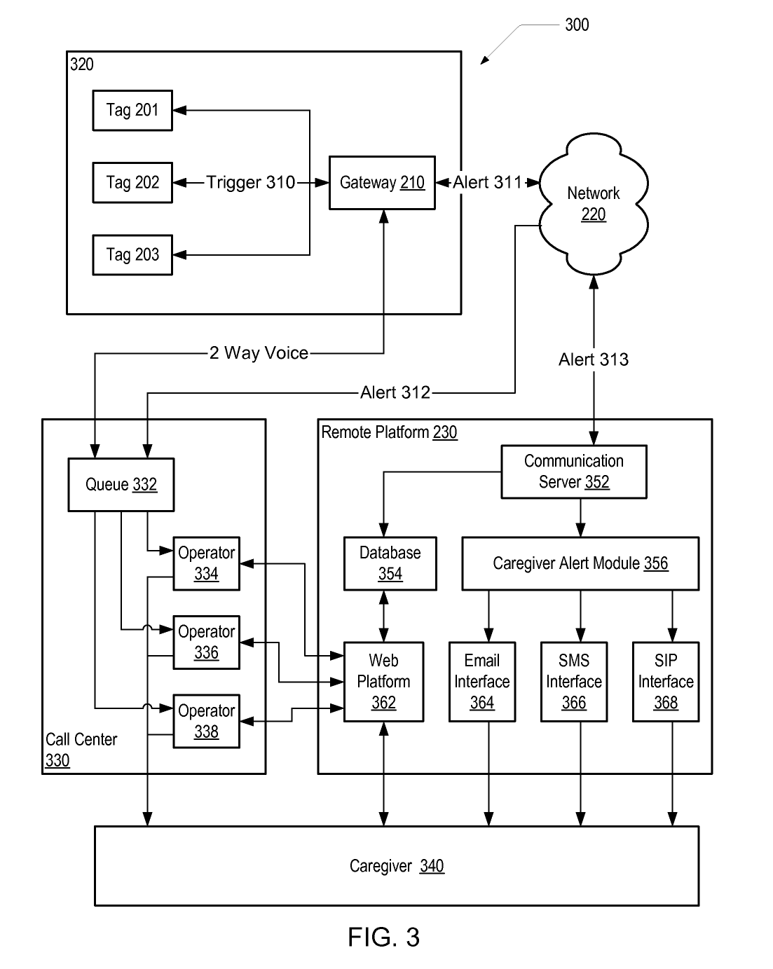

FIG. 3 is a block diagram of one embodiment of a voice triggered emergency alert system 300 for communicating and handling alerts in response to detecting a person's need for help. System 300, as shown, may include a call center 330 and a caregiver 340. System 300 may also include a network 320 coupled to a remote platform 230 via a network 220, as previously described. Network 320 may be coupled to call center 330 directly or via network 220. Call center 330 may be bi-directionally coupled to remote platform 230. Remote platform 230 may be further coupled to caregiver 340.

Network 320, as shown in FIG. 3, is a simplified version of network 200 of FIG. 2. In the illustrated embodiment, network 320 includes tags 201-203 coupled to gateway 210. Call center 330 includes a queue 332 communicating with operators 334, 336, and 338. For simplicity, three operators are shown, although any number of operators may be employed by call center 330. Call center operators may each communicate with caregiver 340 via a telephone or other means, as desired. Remote platform 230 may include a communication server 352 coupled to a database 254 and to a caregiver alert module 356. Remote platform 230 may also include a web platform 362, an email interface 364, a Short Message Service (SMS) interface 366, and a Session Initiation Protocol (SIP) interface 368 for communicating with caregiver 340.

During operation, when an event requiring help occurs within network 320, an alert may be triggered. For example, FIG. 3 shows a trigger 310 between tag 202 and gateway 210. Trigger 310 may cause gateway 210 to communicate the occurrence of the event to call center 330 via alert 312 and to communication server 352 via alert 313. Within call center 330, queue 332 may respond to event 312 by opening a direct 2-way voice communication between an operator and gateway 210. Communication between gateway 210 and a call center operator may include sending the alert condition to the operator. The operator may attempt to communicate with the care recipient and/or determine what steps to take next. In the case of a serious emergency the call center operator may send help to the home of the care recipient, such as by calling emergency services. The operator may alert caregiver 340 via a telephone call or via web platform 362. In some cases, the operator may determine that the alert is a false alarm. If a false alarm is detected, the operator may log the alarm with a flag indicating that it is false and notify caregiver 340 of the event. In alternative embodiments, gateway 210 may communicate with call center 330 via a variety of protocols such as XML Push voice messaging service, Email, SMS, or X25.

Communication server 352 may respond to alert 313 by logging the event in database 354 and sending an alert to caregiver 340 via caregiver alert module 356. Module 356 may use one or more of a variety of interfaces to alert a caregiver. For example, module 356 may contact a caregiver via email through email interface 364, send a text message via SMS interface 366, or a voice-over-IP call via SIP interface 368, etc. Caregiver 340 may configure a monitoring account via web platform 362. For example, notification preferences may be selected and stored in database 354. Caregiver 340 may also monitor alert activity and receive reports via web platform 362.

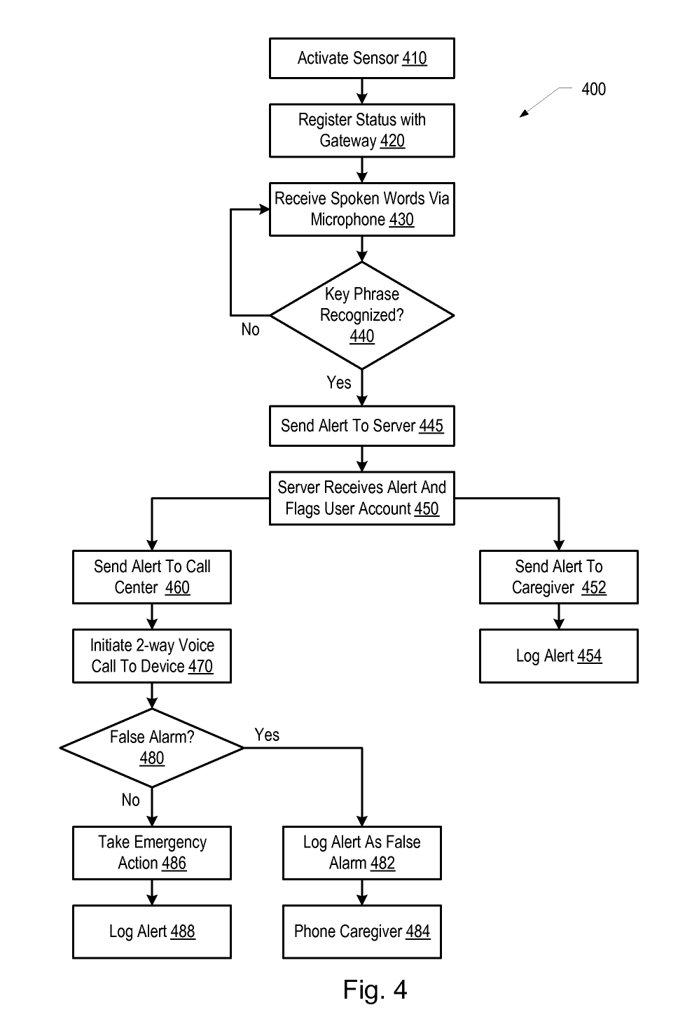

FIG. 4 illustrates one embodiment of a voice triggered emergency alert process 400. Process 400 begins when one or more sensors are activated (block 410). Upon activation, each sensor may register its status with a gateway (block 420) and begin listening for keywords or phrases via a microphone (block 430). If a keyword or phrase is not recognized (decision block 440), listening continues. If a keyword or phrase is recognized (decision block 440), the gateway may send the alert to a server (block 445). In one embodiment, in order to communicate with the server, the gateway may first establish a connection to the server via the Internet or the PSTN. In a further embodiment, the gateway may include the conditions of the alert as data sent to the server. In response to receiving an alert, the server may flag a user account (block 450), send the alert to a caregiver (block 452), and/or send the alert to a call center (block 460). The server may also log the alert's occurrence (block 454). In response to receiving the alert, a call center operator may initiate a 2-way voice call to the alerting sensor (block 470). If it can be determined that the alert is a false alarm (decision block 480), the event may be logged and flagged as false (block 482) and a caregiver notified (block 484). If the event is not a false alarm, or it can't be determined that the alert is a false alarm (decision block 480), then a call center operator may take emergency action (block 486) and log the alert (block 488). Emergency actions may include one or more of calling emergency service (911), contacting a caregiver, etc.

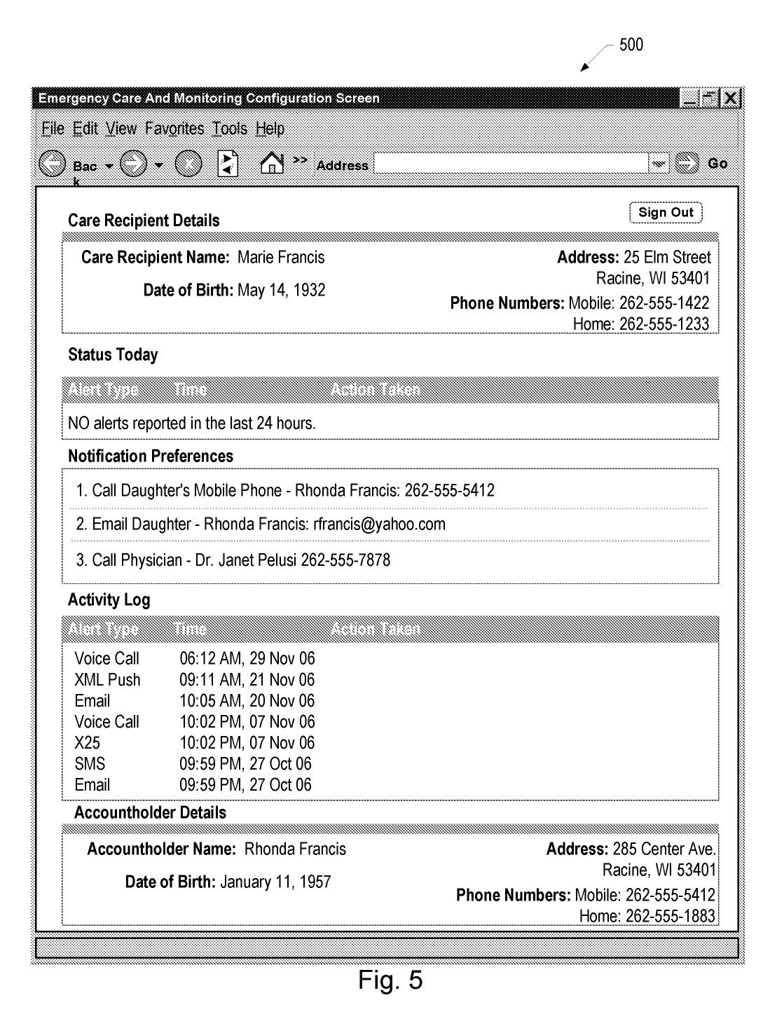

FIG. 5 illustrates one embodiment of a web-based view 500 of part of a database that may be used in a voice triggered emergency alert system. View 500 may include the standard features of a web browser window such as drop-down menus, a navigation bar, and an address field. As shown, view 500 displays data from a database under five main headings: Care Recipient Details, Status Today, Notification Preferences, Activity Log, and Accountholder Details. Care Recipient Details and Accountholder Details include biographical information and contact information for the care recipient and accountholder, respectively. Status Today and Activity Log include information describing the alert type, time of the alert and action taken in response to the alert for the current day and for a selected past time period, respectively. Notification Preferences includes an ordered list of the preferred methods of communication with caregivers to be used in case of an alert. Additional views through which details and preferences may be changed will be apparent to one of ordinary skill in the art and will not be described further herein.

It is noted that the above-described embodiments may comprise software. In such an embodiment, the program instructions that implement the methods and/or mechanisms may be conveyed or stored on a computer accessible medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Still other forms of media configured to convey program instructions for access by a computing device include terrestrial and non-terrestrial communication links such as network, wireless, and satellite links on which electrical, electromagnetic, optical, or digital signals may be conveyed. Thus, various embodiments may further include receiving, sending or storing instructions and/or data implemented in accordance with the foregoing description upon a computer accessible medium.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A voice recognition emergency device comprising:
a transmitter for communication with a gateway; and
a processor configured to:
analyze sound received from a microphone;
detect when an emergency phrase has been spoken; and
convey an alert condition to the gateway via the transmitter in response to detecting the emergency phrase has been spoken.

2. The device according to claim 1, wherein the processor is configured to:
recognize any of a plurality of pre-defined, spoken emergency phrases; and
trigger an alert condition in response to detecting that one of the emergency phrases was spoken.

3. The device according to claim 2, wherein the device is further configured to continuously listen through the microphone for any one of the pre-defined phrases, in response to which an alert condition is conveyed to the gateway device.

4. The device according to claim 3, wherein the alert condition is conveyed to the gateway device through one or more of the following:
Power Line Communications (PLC);
radio communications;
Wi-Fi communications; or
Ethernet communications.

5. The device according to claim 1, wherein the processor is configured to recognize an emergency phrase spoken by a particular person.

6. A system comprising:
a microphone;
a speaker;
a voice recognition emergency device, wherein said device comprises:
a transmitter for communication with a gateway; and
a processor configured to:
analyze sound received from the microphone;
detect when an emergency phrase has been spoken; and
convey an alert condition to the gateway via the transmitter in response to detecting the emergency phrase has been spoken.

7. The system according to claim 6, wherein the processor is configured to:
recognize any of a plurality of pre-defined, spoken emergency phrases; and
trigger an alert condition in response to detecting that one of the emergency phrases was spoken.

8. The system according to claim 7, wherein the device is further configured to continuously listen through the microphone for any one of the pre-defined phrases, in response to which an alert condition is conveyed to the gateway device.

9. The system according to claim 8, wherein the alert condition is conveyed to the gateway device through one or more of the following:
Power Line Communications (PLC);
radio communications;
Wi-Fi communications; or
Ethernet communications.

10. The system according to claim 6, wherein the processor is configured to recognize an emergency phrase spoken by a particular person.

11. The system as recited in claim 6, further comprising:
a call center coupled to the gateway via a network; and
a caregiver coupled to the call center;
wherein in response to receiving the alert condition, the gateway is configured to convey the alert condition to the call center; and
wherein the call center is configured to respond to the alert condition.

12. The system as recited in claim 11, wherein the call center is further configured to respond to the alert condition by summoning help from the caregiver upon determining that the alert is not a false alarm.

13. The system as recited in claim 6, further comprising a caregiver coupled to the gateway, wherein the gateway is further configured to respond to the alert condition by summoning help from the caregiver.

14. A method comprising:
analyzing sound received from a microphone;
detecting when an emergency phrase has been spoken; and
conveying an alert condition to a gateway device via a transmitter in response to detecting the emergency phrase has been spoken.

15. The method according to claim 14, further comprising:
recognizing any one of a plurality of pre-defined spoken emergency phrases; and
triggering an alert condition in response to detecting that one of the emergency phrases was spoken.

16. The method according to claim 15, further comprising continuously listening through the microphone for any one of the pre-defined phrases, in response to which an alert condition is conveyed to the gateway device.

17. The method according to claim 16, wherein the alert condition is conveyed to the gateway device through one or more of the following:
Power Line Communications (PLC);
radio communications;
Wi-Fi communications; or
Ethernet communications.

18. The method according to claim 14, further comprising recognizing an emergency phrase spoken by a particular person.

19. The method as recited in claim 14, wherein in response to receiving the alert condition, the gateway is configured to convey the alert condition to a call center and the call center is configured to respond to the alert condition by summoning help from the caregiver upon determining that the alert is not a false alarm.

20. The method as recited in claim 14, further comprising the gateway responding to the alert condition by summoning help from a caregiver.
